(19) United States
(12) Patent Application Publication
(10) Pub. No.: US 2010/0296907 A1
(43) Pub. Date: Nov. 25, 2010

(54) OVERTURNING APPARATUS

(75) Inventor: Xiong-Gang Cao, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/494,295

(22) Filed: Jun. 30, 2009

(30) Foreign Application Priority Data
May 23, 2009 (CN) 200910302549.5

(51) Int. Cl. B65G 47/248

(52) U.S. Cl. 414/758

(57) ABSTRACT

An overturning apparatus includes a seat, a first gear; a second gear; an overturning board; and a motor. The second gear, the motor, and the overturning board are mounted on the seat. The first gear is coupled to the motor and engages with the second gear. The number of teeth of the second gear is more than the number of teeth of the first gear. The overturning board is fixed to the second gear.

### BACKGROUND

1. Technical Field

The disclosure relates to an overturning apparatus.

2. Description of Related Art

With the development of automation technology, the degree of automation in production is rapidly raising. Large machines are commonly used on automated production lines. However, there is usually a need to turn some of these heavy machines over during the course of production by using a motor with great costly power output. Therefore, what is needed is an overturning apparatus capable of turning heavy objects over with greater efficiency.

### BRIEF DESCRIPTION OF THE DRAWINGS

The components of the drawings are not necessarily drawn to scale, the emphasis instead being placed upon clearly illustrating the principles of an overturning apparatus. Moreover, in the drawings, like reference numerals designate corresponding parts throughout several views.

FIG. 1 is a perspective view of an overturning apparatus in accordance with one embodiment.

FIG. 2 is an exploded perspective view of the overturning apparatus shown in FIG. 1.

FIG. 3 is a perspective view of the overturning apparatus of FIG. 1, viewed from another aspect.

### DETAILED DESCRIPTION

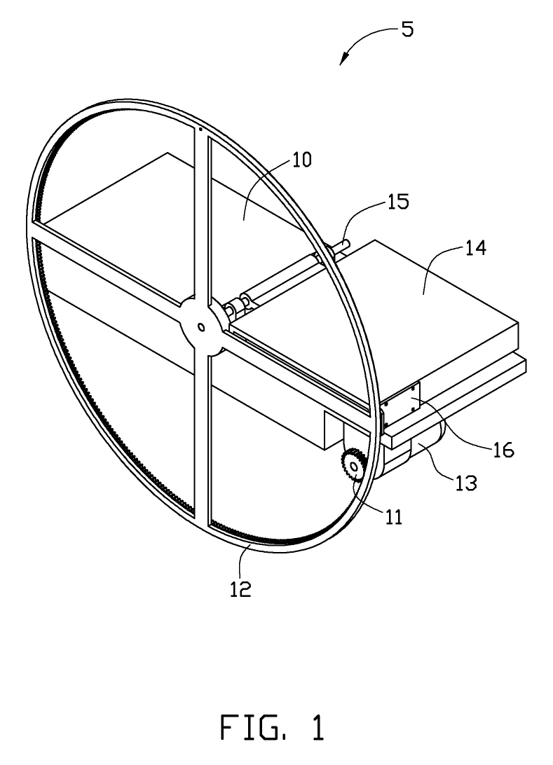

FIG. 1 is a schematic view of an overturning apparatus in accordance with one embodiment. The overturning apparatus 5 includes a seat 10, a first gear 11, a second gear 12, a motor 13, and an overturning board 14. The first gear 11 is coupled to the motor 13. The second gear 12, the motor 13 and the overturning board 14 are all mounted on the seat 10. The overturning board 14 is further secured to the second gear 12.

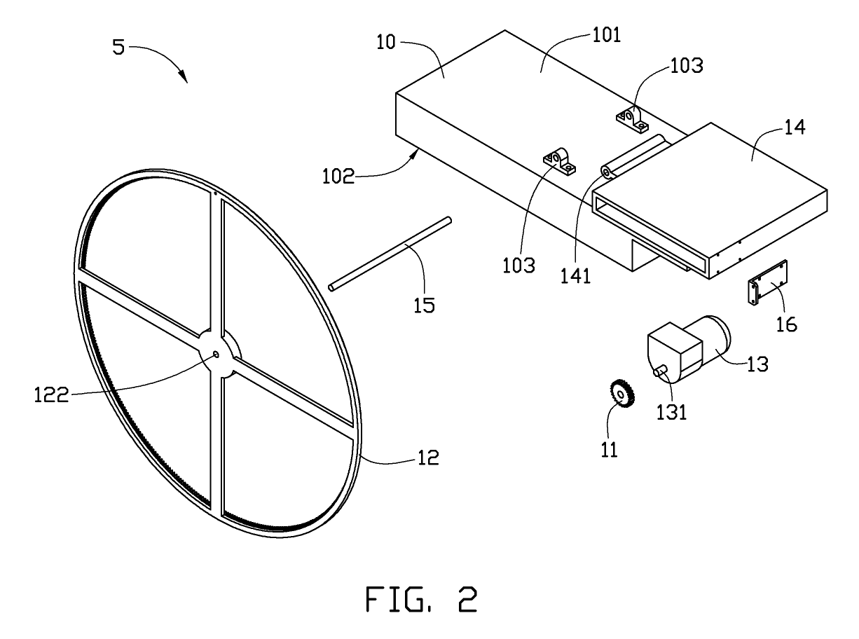

Referring also to FIG. 2, the seat 10 includes a top surface 101 and a bottom surface 102. An axle 15 is rotationally connected to the top surface 101 by two axle supports 103.

The motor 13, mounted under the bottom surface 102, includes a motor shaft 131. The first gear 11 is coupled to the motor shaft 131, and driven by the motor 13 to rotate. The motor 13 may be a step motor or a servomotor.

The number of teeth of the second gear 12 is greater than the number of teeth of the first gear 11. The second gear 12 engages with the first gear 11, such that it is rotated by the first gear 11. The second gear 12 includes an axle hole 122. The axle 15 is received in the axial hole 122. In one embodiment, the second gear 12 is an internally toothed gear, and the first gear 11 is an externally toothed gear.

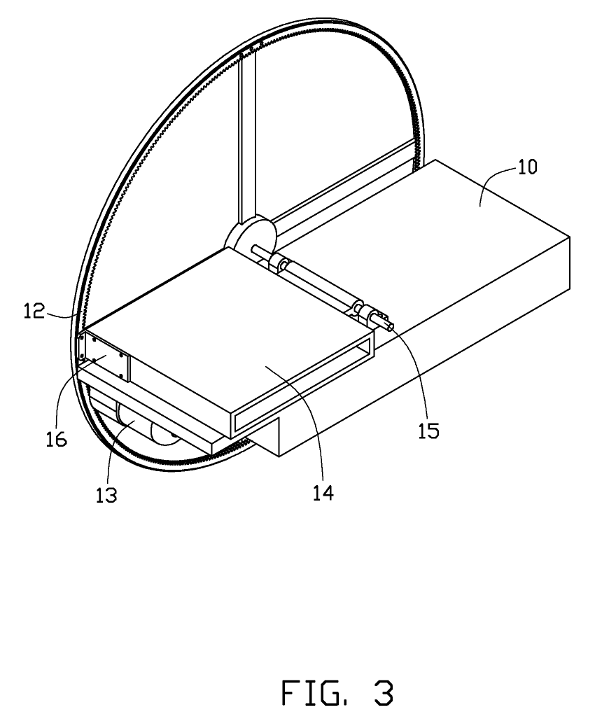

The overturning board 14 includes a through hole 141 which accommodates the axle 15. Accordingly, the overturning board 14 is rotatable relative to the axle 15 and therefore, is rotatable relative to the seat 10. Referring also to FIG. 3, the overturning board 14 is further fixed to the second gear 12 through a connection member 16 and rotates with the second gear 12.

When using the overturning apparatus 5 to turn over objects placed on the overturning board 14. The motor 13 is powered on and drives the first gear 11 to rotate, the first gear 11 drives the second gear 12, and the second gear 12 further drives the overturning board 14 to rotate relative to the seat 10 until the objects placed on the overturning board 14 are overturned.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. An overturning apparatus, comprising:
a seat;
a motor mounted on the seat;
a first gear coupled to the motor and driven by the motor to rotate;
a second gear mounted on the seat, engaged with the first gear, and driven by the first gear to rotate; and
an overturning board fixed to the second gear and driven to rotate with the second gear;
wherein a number of teeth of the second gear is more than a number of teeth of the first gear.

2. The overturning apparatus as described in claim 1, wherein the motor is a step motor.

3. The overturning apparatus as described in claim 1, wherein the motor is a servomotor.

4. The overturning apparatus as described in claim 1, wherein the first gear is an externally toothed gear and the second gear is an internally toothed gear.

5. The overturning apparatus as described in claim 1, wherein both the first gear and the second gear are externally toothed gears.

6. The overturning apparatus as described in claim 1, wherein the overturning board is pivotally mounted on the seat.
